(19) United States
(12) Patent Application Publication
(10) Pub. No.: US 2008/0290090 A1
(43) Pub. Date: Nov. 27, 2008

(54) Pressure cooker

(75) Inventors: Michael Kindler, Darmstadt (DE); Guido Metz, Darmstadt (DE); Maria Mormone, Kuchen (DE); Martin Neumayer, Gerstetten-Dettingen (DE); Dieter Reinhard, Deggingen (DE); Werner Zimmerman, Ginger (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: WMF WUERTTEMBERGISCHE METALLWARENFABRIK AG, Geislingen (DE)

(21) Appl. No.: 11/881,221

(22) Filed: Jul. 25, 2007

(30) Foreign Application Priority Data
Jul. 25, 2006 (EP) 06015511.6

(51) Int. Cl. A47J 27/08

(52) U.S. Cl. 220/203.05; 220/203.01; 220/203.02; 220/203.07; 220/203.1; 220/316

(57) ABSTRACT

A pressure cooker with a handle with an operating element, wherein the operating element comprises a rotating shaft. Also, a pressure cooker with an operating element with which pressure from the pressure cooker can be relieved through an aperture, wherein means are provided with which the pressure can be relieved with at least two specified different pressure relief rates or with at least one specified pressure relief rate and with a pressure relief rate which can be set to greater values than the specified value. Also, a pressure cooker with an operating element for opening and closing an aperture of the pressure cooker, wherein a second operable aperture of the pressure cooker is provided, as well as a pressure cooker with a pressure acquisition device having a mechanical part with at least one part, movable by the pressure, and an electronic part, which can acquire the position of the movable part in order to determine the pressure.

### CROSS-REFERENCE TO RELATED APPLICATION

The present application claims the benefit of priority of European Patent Application No. 06015511.6 filed Jul. 25, 2006. The entire text of the priority application is incorporated herein by reference in its entirety.

### FIELD OF THE DISCLOSURE

The disclosure relates to a pressure cooker.

### BACKGROUND

A pressure cooker with which the cooking material can be cooked in a cooking space under increased pressure and thereby also under increased temperature is known per se.

### SUMMARY OF THE DISCLOSURE

The object of the disclosure is to improve a known pressure cooker.

With a pressure cooker normally various mechanical components are provided with which the cooking space can be opened and closed. In this respect the mechanical elements are used, for example, to open and close apertures in the lid of the pot to facilitate a pressure build-up by heating the pot and/or to carry out a pressure relief.

In this respect, slides are used, for example, to actuate various elements such as pressure valves.

In this respect, it has proved to be disadvantageous that slides must often comprise various components so that the play or the tolerances of the various components add up. In other respects, the number of functions which can be set with a slide is limited. With the pressure cooker an operating element is provided which comprises a rotating shaft. With a rotating shaft additional functions can be actuated and furthermore with a rotating shaft very high precision is obtained so that production tolerances or play are not important or of only insignificant importance.

The operating element with the rotating shaft is coupled to a handle. This handle protrudes sideways from the pressure cooker. In this way the situation is obtained in which the operation of the rotating shaft can take place outside of the region above the pressure cooker, because in this region a hazardous region can arise due to heated air.

To protect the operating element mechanically it is advantageously accommodated, at least partly, in the handle.

In order to bypass the above mentioned hazardous region, it is advantageous if the rotating shaft extends from a region at the side of the cooking space to a region above the cooking space. To the side of the cooking space there is also a region which is arranged higher than the lid or the upper end of the cooking space, but which lies to the side of the cooking space or the lid when viewed from above.

The rotating shaft is preferably fitted with an actuating element and this actuating element is preferably arranged at the end of the handle. Through the arrangement at the end of the handle, the actuating element is situated at the maximum possible distance from the pressure cooker which can be hot and thus ensures a high level of safety when handling the pressure cooker.

The actuating element is in this regard preferably arranged fully to the side of the cooking space.

The rotating shaft preferably has at least two, three, four or even more predefined rotary positions. These are situated within one full rotation and more preferably within just one half, third or quarter rotation of the rotating shaft. Through the various rotary positions various settings of the pressure cooker can be realized, such as for example various cooking levels or an opening of the cooking space for pressure relief or similar action. The rotary positions can for example be predefined by end stops and/or latching positions. When rotating the rotating shaft, predefined rotary positions may for example be provided from which a rotation of the rotating shaft requires a greater torque than a rotation from another position and/or wherein the rotating shaft on its own can enter the predefined rotary positions from a position adjacent to the predefined rotary positions. On rotating the rotating shaft via a predefined rotary position a noticeable latching can be felt.

The various predefined rotary positions can comprise a zero position, at which pressure build-up is not possible, and one or more various cooking levels. Also one or more rotary positions for pressure relief are possible. The rotary position for two or more cooking levels can be arranged on different sides of the zero position or on the same side of the zero position. In the latter case the two cooking levels can be reached by rotation from the zero position in the same direction whereas otherwise a rotation from the zero position must occur in different directions.

The rotation of the rotating shaft is possible without a limit stop, i.e. the rotating shaft can be rotated through many rotations in the same direction. On the other hand, it is also possible to limit the rotation by limit stops. In this case then only rotations up to, for example, a half, third or quarter rotation are possible. Preset rotary settings with associated functions such as the zero setting, cooking levels or pressure relief positions are advantageously provided at the limit-stop positions.

The rotation of the rotating shaft is advantageously possible such that the rotating shaft is not linearly displaced as would be the case with a screw which is rotated.

Preferably one, two, three or more cams are provided on the pressure cooker. Together with a cam follower it is thus possible to set the various mechanical elements of the pressure cooker.

For the mechanical elements found on a pressure cooker cams are particularly advantageous, because corresponding cam followers must normally be tensioned against the cams, which can occur with spring forces, which are however normally already present with pressure gauges or similar devices. Therefore, cams can be particularly effectively employed to exploit the rotational movement of the rotating shaft in pressure cookers.

It is also advantageous for example to provide rocker elements, which interact with the respective cams, because with rocker elements of this nature relatively flat constructions are possible, because then a cam does not need to press directly on that part which is to be adjusted, but rather this is realised mechanically via a rocker in an opposing movement.

Due to the rotation of the rotating shaft it is for example possible to set the maximum specified pressure of the pressure cooker. Above the maximum specified pressure or above a predetermined multiple value (for example 1.5 times the specified pressure) the pressure cooker starts to vent the pressure. In this way a further rise in pressure is prevented.

Furthermore, the release pressure for a time acquisition can for example also be set by the rotation of the rotating shaft. In this respect, a time acquisition is released by a certain release pressure, which signifies that the time acquisition then begins or terminates. Through rotation of the rotating shaft this release pressure can be selected such that various cooking levels for example can be set.

Through rotation of the rotating shaft it is also possible to open the pressure cooker to relieve pressure or to close it. Variously large pressure relief rates can be achieved through different rotary settings.

Apart from the rotation of the rotating shaft, it is also advantageously possible to displace the rotating shaft linearly. In this manner further functions can be actuated with one and the same operating element.

For example, it is possible to open or close the pressure cooker also or instead of the rotational movement by a linear displacement in order to relieve the pressure. The aperture made available by a linear displacement and the aperture made available by a rotation of the rotating shaft can be of different sizes so that through one or the other action different discharge cross-sections are provided to facilitate a fast or slow pressure relief of the pressure cooker.

A variously fast pressure relief is however also possible by a rotation into various rotary positions or through a displacement into various linear actuating positions.

Through rotation and/or displacement of the rotating shaft the pretension of a pressure valve pretensioned with an elastic element, such as a spring, can be varied. Generally pressure valves have elastic elements which deform during a rise in pressure. In this way a pressure valve or a pressure acquisition can be realized. This pretension can be varied by rotation of the rotating shaft to vary the reaction of the respective pressure valve or pressure acquisition device to pressure changes.

In a particularly advantageous embodiment the pressure measurement device comprises an electronic evaluation device. With this device various parameters can be acquired, such as for example the pressure, or the attainment of one or more pressure levels or the exceeding or undercutting of one or more pressure levels or similar parameters.

The pressure measurement device has advantageously a measuring element which can be displaced by the pressure, wherein the electronic evaluation device acquires the position of the movable measuring element for the determination of the pressure. In this version it is possible through mechanical adjustment of the pretension of the movable measuring element to vary the specified pressure from which the electronic evaluation device detects the attainment of a specified pressure.

If this type of movable measuring element should become jammed, it is advantageous if it can be brought externally into an idle position. The idle position is that position which the measuring element normally assumes when no pressure is present in the pressure cooker.

The rotating shaft can be advantageously formed straight. It can then be manufactured from or in one piece, which is advantageous here. It can however also have one or more bending or flexible points, so that the rotational movement can also be transferred around a kink or curve. This facilitates greater freedom in the design of the handle and the arrangement of the elements to be adjusted.

The rotating shaft can be produced just from one material or also from two, three or more materials. It can, for example, have one or more surround-molded metal bars (metal and plastic). The metal bar(s) can have a square cross-section in order to ensure reliable torsional strength of the molded-on plastic. Furthermore, the shaft can be provided with protection against wear, for example a metal cap, at points susceptible to wear (bearing, cam follower, etc.).

As is known, a pressure cooker has an operating element for opening and closing the pressure cooker. With the lid still closed on the pressure cooker, this aperture is used to open or close the cooking space to the external room in order to be able to relieve the pressure in a controlled manner.

The pressure cooker has means by which the pressure can be relieved in at least two specified, different pressure relief rates.

Also a pressure cooker can be provided which has means with which the pressure can be relieved at a predetermined pressure relief rate, and further at a second pressure relief rate, which can however be specified by the user and which can be set up to larger values than the predetermined pressure relief rate.

A slow pressure relief is for example advantageous to prevent the cooking material, in which an internal pressure has built up during the cooking process, being impaired in its consistency due to a too rapid pressure relief. Here a slower pressure relief is advantageous to give the cooking material opportunity to slowly reduce the high internal pressure without being subjected to a change in consistency.

This depends however on the type of cooking material, so that the choice of different pressure relief speeds is advantageous.

The various pressure relief rates can for example be set by a single aperture which is opened or closed to a varying extent. The various pressure relief rates cannot therefore be set by the user, but are rather specified by the constructions of the pressure cooker, for example by different limit-stop positions, latching positions or similar feature of the operating element.

The various pressure relief rates can be achieved however also through different apertures. For example, a second aperture can be provided for the pressure relief. With the two apertures it is possible to open just one or both apertures to facilitate variously rapid pressure relief. The two apertures can have the same or different discharge resistances. The discharge resistance is decisive for the pressure relief rate.

It is also possible that both apertures have different discharge resistances (for example due to different minimum discharge cross-sectional areas), because then an even larger variation in the pressure relief times is possible. The fastest pressure relief is obtained with pressure relief through both apertures, a medium speed pressure relief is obtained with pressure relief through the aperture with the lowest discharge resistance and the slowest pressure relief is obtained with pressure relief through the aperture with the greatest discharge resistance.

In an advantageous embodiment the discharge resistance of at least one of the two apertures or also both apertures is influenced by the pressure in the pressure cooker. If the pressure is high, then the discharge resistance is also high and if the pressure is low, then the discharge resistance reduces. In this way a consistent pressure relief can be obtained. In this respect for example, pressure reduction valves or similar devices can be used which are positioned between the cooking space and the discharge aperture, so that with a pressure in the cooking space above the specified pressure always the same pressure is applied to the discharge aperture. Also other valves or components which change the cross-sectional area can be used for a consistent pressure relief.

The discharge resistances can be set through the choice of various discharge cross-sections.

The pressure cooker can for example be designed such that a pressure of 1 bar overpressure reduces to 0.04 bar overpressure in a specified time between 10 seconds and 2 minutes. Also at least one of the apertures can be formed such that the pressure between the above values reduces in not more than 15 to 5 seconds. With two differently arranged apertures with different cross-sectional areas both fast and also slow pressure relief can be obtained. The pressure figures (from 1 bar to 0.04 bar) are only given here for a definition of the pressure relief rates or discharge resistances. With the same pressure relief rates or discharge rates pressure relief from for example 0.04 to 0.01 bar or from 0.5 to 0.1 bar is possible.

The greater pressure relief rate can advantageously only be set when the pressure has dropped below a specified overpressure (e.g. 0.04 bar). This ensures that no large quantities of hot steam are emitted in a short time which could lead to scalding. A slower pressure relief rate can however be set at any pressure to undercut the predetermined overpressure in order to then change to the greater pressure relief rate.

Both apertures are preferably operated with one and the same operating element.

One aperture can for example be closed by the operating element, in that the operating element presses with a mechanically strong part, such as for example a rotating shaft or a cam arranged on it, onto an elastic sealing element which then on its part closes an aperture on the pressure cooker. If the rotating shaft is not round, then the aperture can be released or closed in different positions.

One of the apertures can also be provided with a pressure valve so that a pressure reduction on reaching a maximum pressure occurs through the aperture. The pretensioning of an elastic element, such as a spring of this pressure valve, can be defined by the operating element.

The first and/or the second aperture is provided in a removable lid of the pressure cooker. The lid is provided at the upper end of the cooking space so that normally only gas exits through the apertures, but not liquid or similar material.

A pressure cooker comprises a pressure acquisition device. With this pressure cooker a mechanical part is provided which comprises a part which is moved by the pressure. Furthermore, an electronic part is provided which acquires the position of this movable part in order to be able to determine the pressure.

The mechanical part of the pressure acquisition device can be adjusted such that the relationship between the pressure and the position of the movable part can be changed.

Thus for example, a specified pressure can be set, wherein through the setting of the specified pressure the mechanical part of the pressure acquisition device is adjusted such that for the various specified pressures the position of the movable part is in each case the same. This simplifies the measurement for different specified pressures with the exploitation of the whole measurement range that is available.

The mechanical and the electronic parts preferably interact without contacting one another, because this normally facilitates systems which are not susceptible to interference.

Furthermore, the situation is attained in that the electronic part can be removed from the mechanical part, preferably without the use of tools. The removal of the electronic part can occur for cleaning purposes or also for other reasons (see below).

The electronic part comprises preferably also a signal transmitter which can produce a signal depending on the acquired pressure.

The signal transmitter can for example comprise an indicator, such as an LED, a display or an acoustic signal generator, such as a sounder or a loudspeaker or a beeper or similar device.

Furthermore, an embodiment is preferred in which the signal transmitter comprises a device which produces a radio signal. In this respect the acquired pressure can be conveyed by radio to other electronic devices. This can for example be used for the control of the stove on which a pressure cooker is placed in order to ensure the attainment of a specified pressure or range of specified pressure or conformance to the same, but can however also initiate all other possible processes, such as the sending of an e-mail, playing a series of tones or music, a telephone message or similar feature.

The signal transmitter is preferably formed such that a signal is produced with the exceeding or undercutting of one or more specified pressures. These are relatively simply acquired and processed signals so that the electronic part of the pressure acquisition device can be formed as simply as possible, but the essential information can be acquired.

After exceeding or undercutting one or more specified pressures a signal can for example also be output for a preset period. For example after undercutting a specified minimum pressure, such as say 0.04 bar, a signal can still be output for a period of 5 minutes or also more or less, such as for example any period between a half of a minute and 10 minutes, which indicates that the minimum pressure has been undercut.

The signal transmitter can preferably produce a signal continuously or quasi-continuously. Thus the pressure value can be acquired continuously or quasi-continuously. The pressure can be output absolutely, i.e. in pressure units or relative to a specified value. The latter can for example occur in percentage figures.

A signal of this nature, which is produced in very short time intervals, such as every second or every tenth of a second or similar period, is also regarded as quasi-continuous.

The pressure acquisition device is preferably coupled to a time measurement device. In this way the time that a certain pressure is present can be acquired.

The mechanical part can preferably be reset externally for the case when it has become jammed.

A pressure cooker has a time measurement device. When cooking with a pressure cooker generally only the control of the time is available, because in the closed pressure cooker with pressure built up a control of the cooking state is only possible by relieving the pressure and opening the pressure cooker. Consequently, it is advantageous if the pressure cooker itself comprises a time measurement device, because the control of the time is simplified.

It is particularly advantageous if the time measurement device is coupled to a pressure acquisition device. This coupling can for example be arranged such that a time measurement is initiated with the exceeding of a set specified pressure. For pressure cooking generally only the time at the specified pressure or at the highest pressure is relevant, because here the cooking takes place the quickest. Thus, generally the time from reaching this specified pressure is sufficient for the acquisition of the required cooking time.

The specified pressure at which the time measurement is initiated is preferably selectable, wherein this definition preferably occurs mechanically and/or electronically. If for example the pretension of an elastic element is mechanically adjusted such as a spring with a pressure acquisition device, then also the specified pressure is changed at which the time measurement is initiated. However an electronic adjustment of the specified pressure is also possible in that the pressure is acquired electronically and the threshold, at which the time measurement is initiated, is set differently electronically.

The time measurement can also be initiated manually wherein the time measurement device preferably comprises an actuation device. This actuation device can be for example a button or similar feature.

Furthermore, preferably setting means are provided with which a time span can be set. Here it is possible for example to set the previously determined cooking time, such as a time span of 5 minutes or a similar period. This type of time span can for example be given in the operating instructions, in cook books or similar items.

The time measurement device calculates the remaining time of this time span from initiation of the time measurement and can preferably indicate it. However it would also be possible to indicate the expiry of a time span of this nature without indicating the remaining time. For better information for the user, it is however advantageous to indicate the remaining time.

The time measurement device can preferably be removed. This occurs preferably without using tools. Thus, once the cooking process has been initiated by heating the pressure cooker, the appropriate specified pressure has been reached and the time measurement has been initiated, it is possible for example, to remove the time measurement device to be able to follow the time measurement from a place other than in the vicinity of the pressure cooker. For example, the room in which the pressure cooker is being heated can be left and a user can continue to follow the time measurement.

In this respect it is in particular advantageous if at least the time measurement remains functional for the case where the time measurement device has been removed.

The time measurement device can then also be replaced during the cooking process and preferably detects the new pressure position, processes it and issues an updated signal.

The time measurement device can also be formed such that it detects when it is not placed on the pressure cooker. It then does not issue any signals representing a pressure. The time measurement device can however also retain the last signal output before being removed.

The time measurement device is preferably formed such that it can produce a termination signal after the expiry of the set time span. The set time span can preferably also be corrected or defined while the time measurement is running. If for example 3½ minutes have already expired from a set time span of 5 minutes, the remaining time can for example be adjusted to 2½ minutes or 2 minutes or set to another time value. In this respect possible adjustment by in each case 1 minute and/or 1 second is advantageous.

If for example the temperature and the pressure in the pressure cooker reduce during the cooking process, the necessary cooking time can be increased in this manner.

The termination signal can be indicated visually or acoustically. It is also possible to pass the termination signal to a radio signal generation device, which conveys a termination signal by radio. The termination signal can for example be received by a stove which then terminates the heating of the pressure cooker. Also the termination signal can be in a telephone call, e-mail, electronic message, the playing of a series of tones or music or similar feature.

A non-rechargeable or rechargeable battery, a fuel cell, solar cell, Seebeck element, or an element which exploits the steam energy can be used for the power supply of the time and/or pressure measurement device.

Furthermore, preferably means are provided with which a termination signal is output for a preset time.

### BRIEF DESCRIPTION OF THE DRAWINGS

Preferred embodiments are illustrated in the drawings. In this respect the following are shown:

FIG. 1 a three-dimensional schematic view of a pressure cooker;

FIG. 2 a schematic three-dimensional drawing of a disassembled pressure cooker;

FIG. 3 a schematic sectional drawing of a handle and a lid of a pressure cooker;

FIG. 4 a plan view of a handle;

FIG. 5 a plan view of a lid;

FIG. 6 a schematic illustration of a device for closing an aperture of a pressure cooker;

FIG. 7 a three-dimensional schematic sectional illustration of a pressure acquisition device;

FIG. 8 a schematic sectional drawing of the pressure acquisition device of FIG. 7;

FIG. 9 a three-dimensional schematic view of the pressure acquisition device from FIGS. 7 and 8;

FIG. 10 a schematic sectional drawing of a pressure relief valve;

FIG. 11 a three-dimensional schematic illustration of the pressure relief valve of FIG. 10;

FIG. 12 a schematic sectional view of the adjustment mechanism of the pressure valve of FIGS. 10 and 11;

FIG. 13 a three-dimensional schematic illustration of the parts of an aperture latch;

FIG. 14 a schematic illustration of the pressure variation during a cooking process with various characteristic times;

FIG. 15 two views of a time measurement device and/or an electronic pressure acquisition device;

FIG. 16 various views of a pivot bracket for the shaft;

FIG. 17 various views of the handle parts;

FIG. 18 schematic views of a locking mechanism.

### DETAILED DESCRIPTION OF THE DISCLOSURE

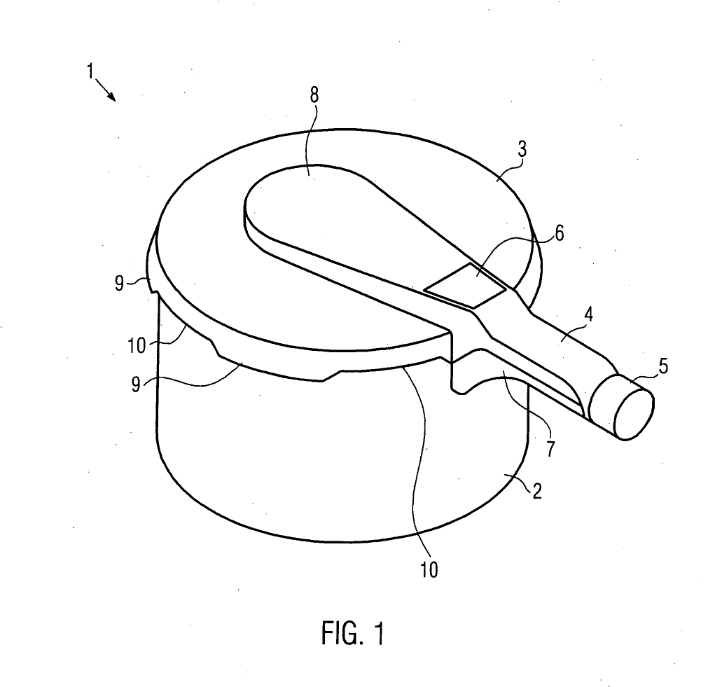

FIG. 1 illustrates a pressure cooker 1. The pressure cooker has a pot 2 which can be closed with a lid 3. The pressure cooker has a handle 4 consisting of two parts 7, 8. The part 7 is joined to the pot 2 and the part 8 is joined to the lid 3. This joint can preferably be released.

At the end of the handle 4 (far right in FIG. 1) an actuating element 5 is arranged. As can be seen in FIG. 1, this actuating element is arranged to the side of the region above the pot 2, that is above the cooking space. In this position actuation of the actuating element 5 is not hazardous.

The lid 3 can be rotated on the pot 2 for opening and closing the pot, wherein this can occur by rotating the handle parts 7 and 8 relative to one another.

The lid 3 has at its edge sections 10 bent inwards which are arranged between unformed regions 9. With these sections 10 the lid can be held on the pot according to a type of bayonet connection.

An electronic part 6 is integrated into the handle 4. This is preferably removable.

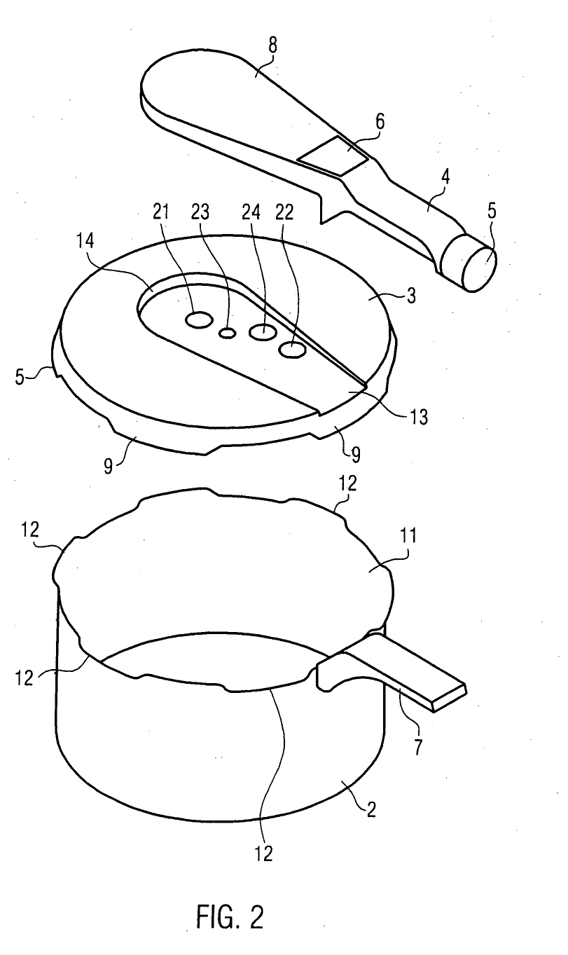

In FIG. 2 the cooking pot is shown in an illustration in which the lid 3 is removed upwards from the pot 2 and the handle 4 is illustrated removed upwards from the lid 3. In this illustration the sections 12 can be seen on the upper edge of the pot which are bent outwards and which engage with the inwardly bent sections 10 of the lid 3 to keep the lid 3 on the pot 2 when under pressure. Inside the pot 2 there is the cooking space 11. A seal which closes the region between the pot 2 and the lid 3 when the pot is closed can be arranged in the lid 3 or on the edge of the pot.

Whereas the handle part 7 is permanently arranged on the pot 2, for example with a screw or similar feature, the handle 4 can be released from the lid 3 without the use of tools. This simplifies cleaning, both of the lid 3 and also of the handle 4.

As can be seen in the illustration in FIG. 2, the lid 3 has an indentation 13 which terminates with a chamfer 14 on the end of the indentation 13 pointing to the left. This chamfer 14 is used to facilitate a controlled emission of gas from the pressure cooker 1 in a direction radiating relative to the horizontal at 10 to 60°, preferably 30 to 50°.

The lid 3 has a number of apertures 21 to 24 in the indentation 13. The number of apertures 21 to 24 need not necessarily be arranged in an indentation 13.

The indentation 13 is also used to arrange the handle 4 deeper in the lid 3 so that the pressure cooker 1 overall has a lower assembled height. Also the shape of the lid can act with the indentation as a centering aid for placing on the handle 4.

The function of the various apertures 21 to 24 is explained below.

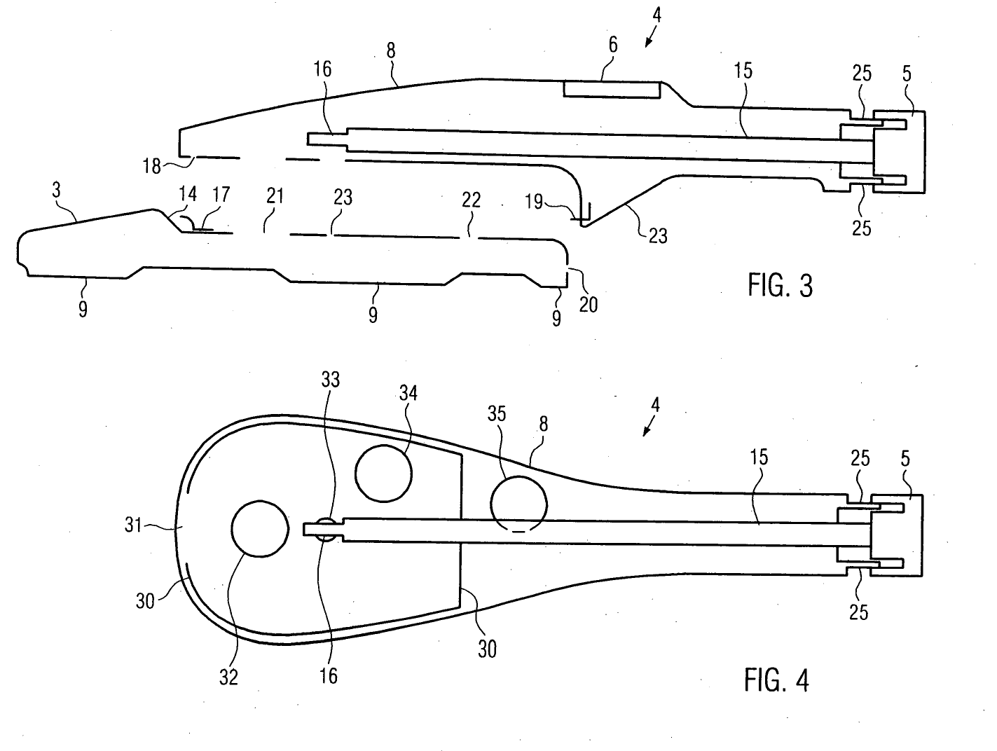

In FIG. 3 a section through a central plane of the handle 4 and the lid 3 is illustrated. In FIG. 3 the actuating element 5 of the handle 4 is illustrated to the right. In contrast to FIGS. 1 and 2 this is illustrated in a position displaced to the right. The actuating element 5 can be both rotated as well as moved in the plane of FIG. 3 to the right and left.

A shaft 15 is connected to the actuating element 5, wherein the joint here can be formed in various ways. For example, a joining technique with a screw, latching hook or similar component is possible. It is also possible to form the shaft 15 and the actuating element 5 as one piece.

The shaft 15 has a constriction 16 at its end to simplify the bearing support of the shaft 15. This constriction 16 is however not necessary.

On its upper side (in the indentation 13) the lid 3 has a hook 17 and an aperture 18 of the handle 4 can be engaged in this hook 17, wherein the handle 4 then can be swiveled around the hook 17 downwards in the horizontal with a swivel movement. A displaceable hook 19 in the handle 4 can latch into an aperture 20 of the lid 3. In this way the handle 4 and the lid 3 are firmly joined together. The lid 3 and handle 4 can be separated from one another by moving the hook 19 in FIG. 3 to the right and swiveling the handle 4 upwards around the hook 17.

In FIG. 3 the section shows the aperture 21 and a sideward offset aperture 22. Furthermore, a small aperture 23 is illustrated.

As can be seen in FIG. 3, the chamfer 14 has an angle of approx. 45° to the horizontal in order to obtain a gaseous emission from the pressure cooker in a direction diagonally upwards. In this way it is possible to direct the steam into the region of an extraction hood or similar device to reduce moisture deposition or soiling of the walls or similar features in a kitchen.

The hook 19 is arranged on a part 23 of the handle 4 which protrudes downwards. In this way it is possible to arrange the handle 4 around a corner of the lid 3 to facilitate a good locking of the handle 4 or of the part 8 on the lid 3.

FIG. 4 shows a schematic illustration of the handle 4 viewed on the handle from above. Here, only selected elements are shown, because they would otherwise be covered by other elements. The handle 4 comprises a pressure indicator 32, means 33 for closing an aperture 23, a pressure valve 34 and a pressure acquisition device 35 which are explained in more detail below.

On the underside of the handle 4 a seal 30 is arranged, which at least encloses the aperture 33 and the pressure valve 34 such that gas emitted there is output to the left at an aperture 31 of the seal 30 in FIG. 4. The gas emitted from the aperture 31 of the seal 30 is directed onto the chamfer 14 in the lid 3.

As can be seen in FIG. 4, the shaft 15 is arranged above or adjacent to the means 33, the pressure valve 34 and the pressure acquisition device 35.

The shaft 15 is illustrated simplified in FIGS. 3 and 4. Details of the shaft 15 are explained in the following figures.

On the surface labelled with 25 a colored or a symbolic marking or a text can be applied. It can thus be indicated that with a fully extended actuating element 5 the lid 3 of the pot 2 can be removed by rotation. The marking can for example be green or a symbol which symbolises the opening of the lid. The marking or the appropriate text is then only visible when the actuating element has been pulled out so far that the lid can be rotated.

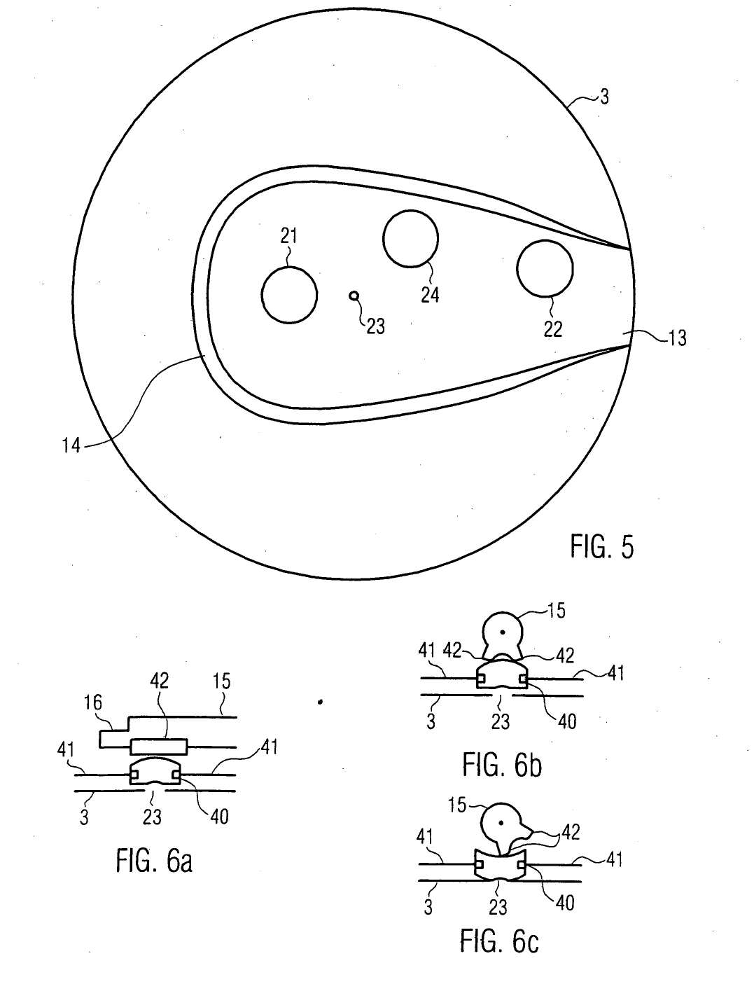

A plan view onto the lid 3 is illustrated in FIG. 5.

The lid 3 has four apertures, wherein the apertures 21 and 23 lie on the central axis of the indentation 13 and the apertures 24 and 22 however lie adjacent to the central axis. The aperture 23 is significantly smaller than the aperture 24. Gas from the cooking space can be emitted through these two apertures. The other apertures are closed such that an emission of gas is not possible.

The aperture 21 is intended for the pressure indicator 32, the aperture 23 for closure with the element 33 from FIG. 4, the aperture 24 for the pressure valve 34 and the aperture 22 for the pressure acquisition device 35.

In FIG. 6a part of the lid 3 is illustrated in a sectional view. The section runs along the shaft 15. The handle 4 or the part 8 has a lower plate 41, which, as described in FIG. 3, is fixed above the lid 3. An elastic element 40, such as a rubber element, is arranged in this plate 41. The shaft 15 runs above this elastic element 40. The element 40 is arranged over the aperture 23 in the lid 3.

The shaft 15 has one or more cams 42. A section perpendicular to the section of FIG. 6a is illustrated in FIG. 6b. The shaft 15 is here situated in a central position in which cams 42 can be seen both to the right and to the left.

In FIG. 6c a situation is illustrated in which the shaft 15 has been rotated by about 30 to 40°. Through this rotation the cam 42 as a solid mechanical part presses onto the elastic element 40 (sealing element) and deforms it downwards so that it closes the aperture 23. The other cam 42 would lead to the same deformation through a rotation of the shaft 15 in the opposite direction (starting in FIG. 6b). The aperture 23 is thus always closed in the rotated positions.

The aperture 23 is however open in the central position (refer to FIG. 6b).

A rotation of the shaft 15, starting in FIG. 6b, to the right or left (refer to FIG. 6c) corresponds to the rotation of the shaft 15 into two different cooking levels. This is explained in further detail below. The central position (refer to FIG. 6b) corresponds to a zero or idle position, because here the aperture 23 is open so that a pressure build-up in the pressure cooker is not possible.

Also when the rotation to the right or left is to realise two different cooking levels, then the cams 42 are the same or symmetrical, i.e. the sealing of the aperture 23 is the same also for different cooking levels. However, with different cooking levels also different levels of pressure can be exerted on the elastic element 40. The cams 42 can thus also be different.

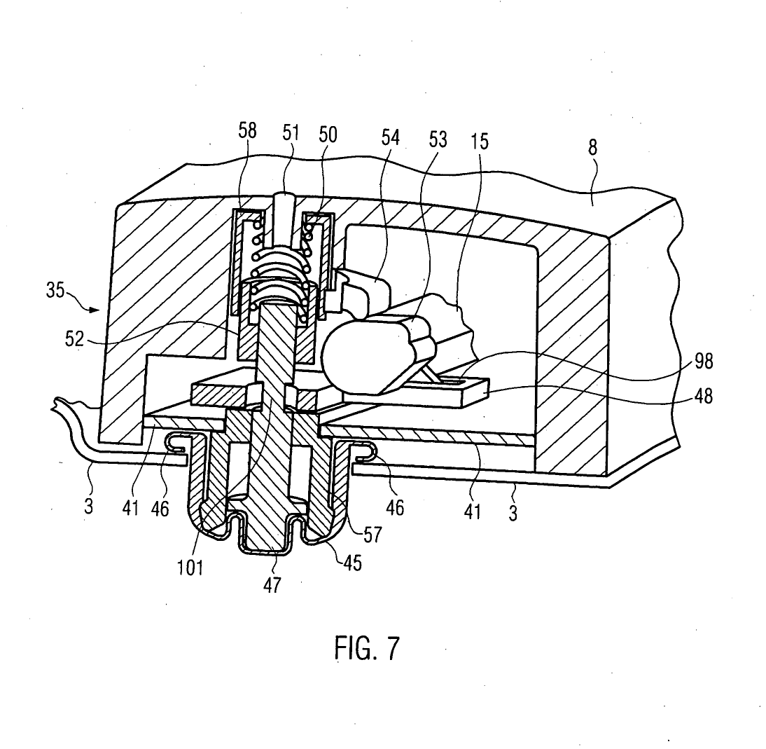

FIG. 7 illustrates the pressure acquisition device 35 in a three-dimensional section. Here, the lid 3 is illustrated in the lower part in the region of the indentation 13 (refer to FIG. 5). Here, the region around the aperture 22 (refer to FIG. 5) can be seen. A rubber bellows 45 is inserted into this aperture 22 from above. The rubber bellows is attached to the handle 8. The handle has a lower plate 41 into which a retainer 57 is inserted. This retainer 57 holds the rubber bellows 45. The rubber bellows 45 has end sections 46 which seal closed on compression between the lid 3 and the plate 41. The rubber bellows 45 has folds at its lower end which facilitate a movement of the central part of the rubber bellows 45. In FIG. 7 the movement takes place up and down. A piston 47 is arranged in the central part. This has an edge which facilitates guidance of the piston 47 through the retainer 57 during an up and down movement.

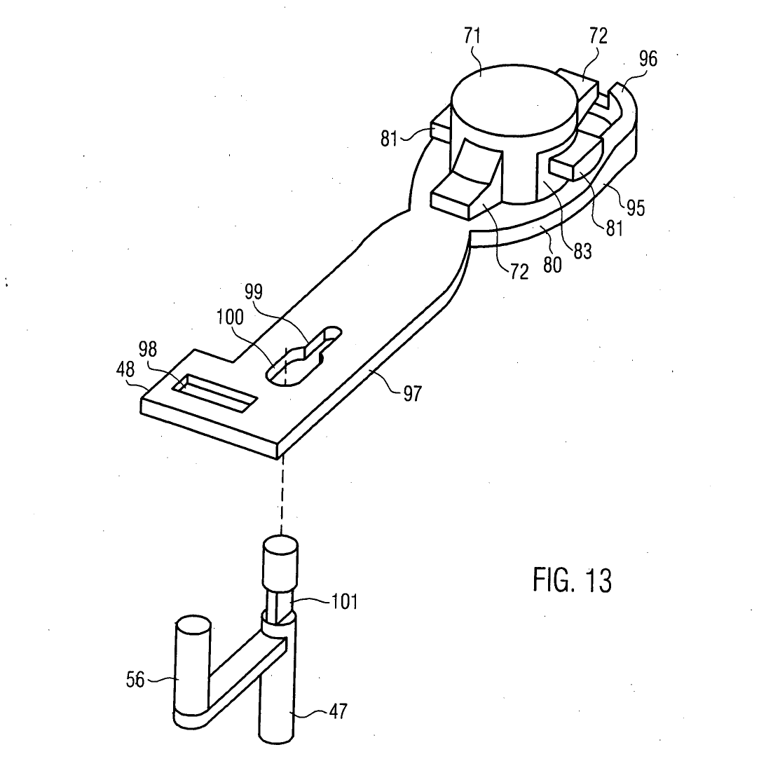

The piston 47 extends upwards through an aperture in the plate 41. The piston 47 has a constriction 101 which will be explained in more detail with reference to FIG. 13.

At the upper end of the piston 47 a pot-type structure 52 is formed into which a spring 50 can be inserted from above. The spring 50 is here guided between the upper end of the piston 47 and the pot-type structure 52. The pot-type structure 52 is in turn guided in an inverse pot-type structure 58.

The upper end of the spring 50 is arranged around a tubular section 51 so that the spring 50 is held in its position. This section 51 comprises an upper hole in the handle 8. A pin, nail, needle or similar item with which pressure can be exerted on the piston 47 from above if it should become jammed can be inserted through this aperture or this tubular section 51.

The upper end of the spring 50 rests on the inner end, located at the top, of the pot-type structure 58.

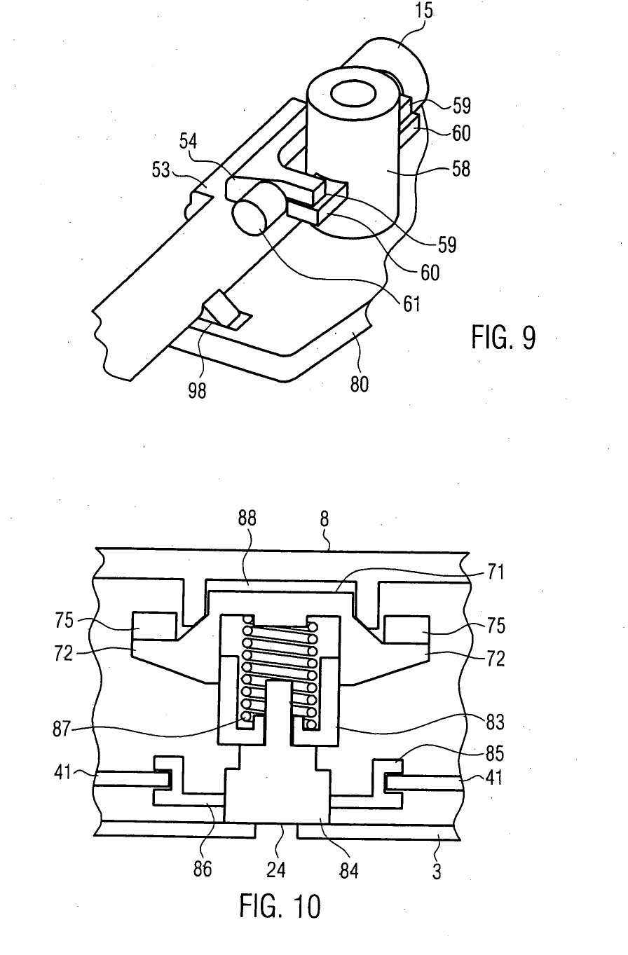

In FIG. 7 the shaft 15 with the cam 53 is illustrated. The cams 53 interact with a cam follower 54 as will be explained with reference to FIG. 9. The cam 53 has an indentation in its center which with the cam follower pretensioned against the cam defines a latching position (predefined rotary position). The cam is asymmetrical to the right and left of this indentation in order to realise different cooking levels. With the rotary position illustrated in FIG. 7 the rotating shaft is in a position in a cooking level.

Furthermore, a component 48 is illustrated in FIG. 7 which will be explained in more detail in FIG. 13.

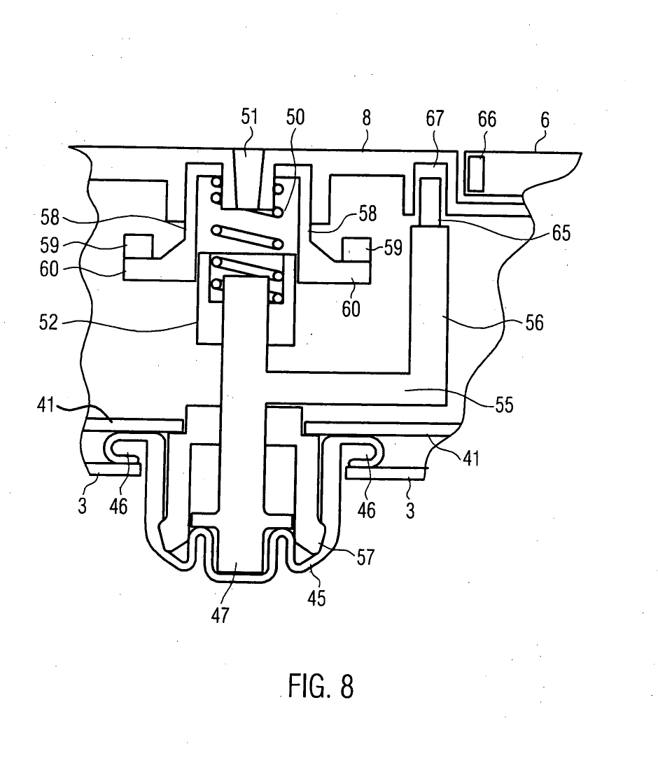

In FIG. 8 a schematic section through the pressure acquisition device 35 from FIG. 7 is illustrated, wherein the section is perpendicular to the section in FIG. 7. In FIG. 8 the rubber bellows 45 can be seen with the piston 47.

The piston 47 has a part 55, positioned to the right in FIG. 8 and to the rear in FIG. 7, to which a second perpendicular part 56 connects. In this section the piston 47 has the structure of a rotated small letter h.

The upper pot-type structure 58, which presses up against the spring 50, has protuberances 60 in the section in FIG. 8. The ends 59 of a rocker element can press onto these protuberances 60 (refer to FIG. 9). When these ends 59 press the protuberances 60 in FIG. 8 downwards, the spring 50 is pretensioned more strongly. For the pressure in the cooking space to press the piston 47 upwards a higher pressure or higher force is thus necessary here. The relationship between the position of the piston 47 (also designated as a displaceable measuring element or mechanical part) and the pressure in the cooking space is thus changed.

A pin 65 is arranged on the upper end of the arm 56. This can be moved up and down in a space 67 depending on the movement of the piston 47. As well as this pin 65, a position detector 66 is arranged. If the pin 65 is for example ferromagnetic or is made of an easily magnetised material, then a modified Hall voltage or similar effect can be used in the detector 66 for the detection of the position of the pin 65. Any other type of position detection of the pin 65 is possible. For example, it can also change the capacitance of a capacitor in the detector 66, wherein this change is acquired for acquiring the pressure.

The detector 66 and the pin 65 operate without contact. The detector 66 is part of the electronic part 6 which is preferably removable. An indentation is provided for this in the upper side of the handle 8.

The pressure acquisition device from FIG. 8 is not intended for the pressure relief, but rather only for acquiring the pressure. This pressure acquisition can be adjusted mechanically.

As can be seen in the three-dimensional drawing in FIG. 9, the shaft 15 has cams 53 which interact with a cam follower 54. The cam follower 54 is arranged on a rocker, wherein the ends 59 are at the other end of the rocker (refer also to FIG. 8). The upper pot-type structure 58 is pretensioned upwards by the spring 50. The cam follower 54 is thus pretensioned against the cams 53 via the mechanical transfer of force by the rocker. Various relationships between the deflection of the piston 47 and the pressure in the cooking space can be obtained by cams 53 of different height on the shaft 15.

The rocker is supported for rotation about an axle 61, wherein the axle is located between the cam follower 54 and the end 59. The rocker is formed such that it can act upon the pot-type structure 58 at two oppositely located sides.

The shaft 15 also has a projection which protrudes into an indentation 98 of a part 80 which will be explained in more detail with reference to FIG. 13.

Different cooking levels can be set by different cams 53 on the shaft 15. Different cooking levels imply different specified pressures. Depending on the preselected cooking level or the preselected specified pressure the element 65 always reaches the same position during a pressure build-up in the cooking space, so that for the detector 66, irrespective of the cooking level, always only one specified position of the element 65 signifies that the specified pressure has been reached. If a large cam is positioned at the cam follower 54 through the rotation of the rotating shaft 15, then the pot-type structure 58 is moved very substantially downwards whereupon the pretension is substantially increased by the spring 50. Now a high pressure is required to bring the element 65 into the position at which the detector 66 detects the attainment of the specified pressure. With a smaller cam 53 this position is attained already with a lower pressure.

In this way the pressure at which the reaching of a specified pressure is to be defined can be varied by rotating the rotating shaft 15, wherein the position of the element 65 at which the reaching of a specified pressure is to be defined is however always the same. In this way the electronic system of the sensor 66 can be designed as simple as possible.

For the aperture 21 (refer to FIG. 5) a bellows, as in FIG. 7 under reference numeral 45, is provided to close this aperture. In the bellows a piston, pretensioned with a spring, is provided, the upper end of which can protrude upwards out of the handle depending on the pressure in the cooking space. Through this pressure indication the pressure in the cooking space can be indicated so that it is easily seen from outside.

A pressure relief valve 34 is schematically illustrated in FIGS. 10, 11 and 12. In FIG. 10 an aperture 24 in the lid 3 is illustrated. An elastic element 86 is arranged above the lid 3 and above the aperture 24. The elastic element 86 is held in an aperture in the plate 41 of the handle 8. The elastic element 86 can be deformed. In the elastic element 86 a plunger 84 is arranged which can close the aperture 23.

At its upper end the plunger 84 is enclosed by a pot-type structure 83 which is enclosed from above by a pot-type structure 71. Both pot-type structures can move with respect to one another.

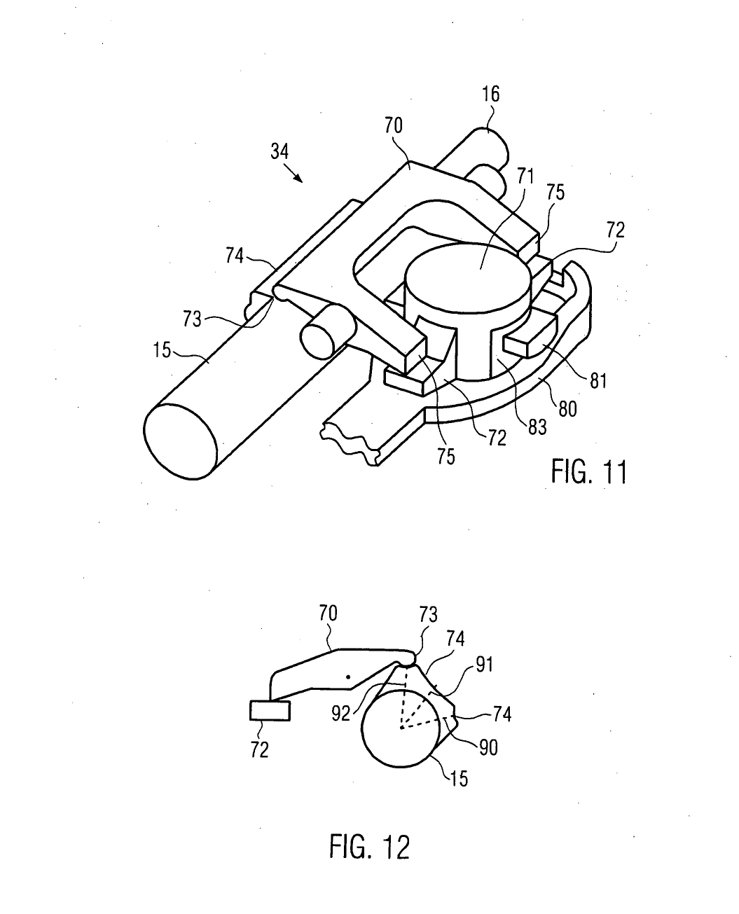

Between these two pot-type structures a spring 87 is arranged which presses the two structures apart. Consequently, the plunger 84 is pretensioned downwards by the spring 87. The tension however depends on the position of the upper pot-type structure 71. This structure is guided by pins or a ring protruding from the upper side of the handle 8. Whereas the spring 87 pretensions the upper pot-type structure 71 upwards, the ends 75 of a rocker 70 (refer to FIG. 11) can pretension the pot-type structure downwards. Consequently, the ends 75 of the rocker 70 can press downwards onto the protuberances 72 of the upper pot-type structure 71.

As illustrated in FIG. 11, the rocker 70 is supported for rotation about a rotating axle which is positioned between a cam follower 73 and the ends 75 of the rocker. Here too, the rocker is formed such that it surrounds the pot-type structure 71 and can press onto this pot-type structure on two oppositely located sides.

The rocker 70 with the cam follower 73 is adjusted by the rotation of the shaft 15 with the cam 74. In this way the pretension of the spring 87 of the pressure relief valve can be set. If the rotating shaft 15 is in such a position that the rocker is substantially deflected, it presses the upper pot-type structure 71 far downwards with the ends 75. Consequently, through the force of the spring 87 the plunger 84 is moved downwards so that the aperture 24 is closed. If an increased pressure builds up in the cooking space, then this pressure presses against the plunger 84 and therefore against the force of the spring 87. If the pressure becomes too great, then the pressure can move the plunger so far away that the aperture 24 is at least slightly released so that the overpressure can reduce. The gas emitted here leaves the region between the lid 3 and the handle 4 through the aperture 31 of a seal 30 (refer to FIG. 4).

As illustrated schematically in a drawing depicting a section through the rocker 70 in FIG. 12, different cams 74 can deflect the rocker 70 by different amounts. The lengths of the lines 90, 91 and 92 are different. In a central position the cam follower 73 is located at the end of line 91 and is thus relatively slightly deflected. This signifies that the upper pot-type structure 71 is not pressed downwards so that the valve 34 can be opened with relatively little counter pressure.

This position corresponds to the central position mentioned above.

By rotation of the rotating shaft from this central position to the right or left the cam follower 73 is brought into contact with the cam 74 at the end of line 90 or 92. The lines 90 and 92 have different lengths, which signifies that the position of the cam follower 73 has rather different distances to the center of rotation of the shaft 15. In this way various deflections of the rocker 70 are possible. In this way different pretensions of the spring 87 are set and thus different pressures specified at which the pressure valve 34 releases the aperture 24. The pressure at which the pressure valve 34 opens can, for example, be x times (about 1.5 times) the specified pressure. The specified pressure can be that pressure at which the pressure acquisition initiates a time measurement.

The upper pot-type structure 72 can also be pretensioned downwards with a spring in the space 88 (e.g. in the form of a leaf spring; not illustrated). Consequently, the plunger 84 is pretensioned downwards via the spring 87 in order to have a certain minimum pretension downwards for the plunger 84 independently of the rocker, so that the aperture 24 is closed with a lack of pressure in the cooking space or with low pressure in the cooking space.

Protuberances 81, as can be seen in FIG. 11, are arranged on the lower pot-type structure 83. The function of these protuberances 81 is explained in FIG. 13.

In FIG. 13 the shaft and the rocker from FIG. 11 have been omitted so that a sliding part 80 is visible. This is a sliding part which can be moved in the direction along the shaft 15 (refer to FIG. 11). To facilitate this, the shaft 15 engages a protuberance in a recess 98 of the sliding part 80 (refer also to FIGS. 7 and 9).

The sliding part 80 has a flat part 97 and an end part with a chamfer 95. This chamfer engages under the protuberance 81 of the lower pot-type structure 83. If the sliding part 80 illustrated in FIG. 13 is pulled to the left at the front, then this protuberance 81 slides along on the chamfers 95 and is pushed upwards by the movement of the sliding part 80 against the force of the spring 87. In this way the influence of the rocker 70 is cancelled. The aperture 24 is thus opened independently of the spring 87 or the rocker position.

The lower pot-type structure 83 has two opposing protuberances 81 which are both operated by the sliding element 80.

The movement of the sliding element 80 is caused by a linear movement of the shaft 15. Through the linear movement of the shaft 15 the pressure valve 34 can thus be opened such that pressure relief is in any case possible through the aperture 24.

The sliding part 80 encloses the upper pot-type structure 71 and the lower pot-type structure 83 in a type of ring shape. In this way a sliding of the sliding structure 80 too far to the left at the front in FIG. 13 is prevented. The end 96 of the sliding structure 80 here moves until stopped by the upper pot-type structure 71. This prevents the rotating shaft 15 from being pulled out further than the position illustrated in FIGS. 3 and 4.

Through the displacement of the sliding part 80 a fast pressure relief can be achieved also at high pressure.

Through the linear displacement of the rotating shaft also unlocking of the lid 3 should be achieved such that the lid 3 can be rotated with respect to the pot 2 and removed. This must not however occur with pressure in the pot, because this can lead to the sudden release of large quantities of steam and consequently to a high risk of injury.

In order to prevent this movement of the rotating shaft and thus also that of the slider 80 if there is pressure in the pot, a keyhole type of aperture 99 is provided in the slider 80. This aperture 99 interacts with the piston 47 of the pressure acquisition device 35. The piston 47 of the pressure acquisition device 35 has a constriction 101 (refer also to FIG. 7). In one position of the piston 47 the narrow part of the keyhole type of aperture 99 can be displaced along the constriction 101 of the piston 47. If however there is pressure in the cooking space and the piston 47 is in a raised position in which the piston 47 is located with its round region or with its extended region in the extended aperture 100 of the keyhole type of aperture 99, then displacement of the sliding part 80 is blocked by the piston 47. It is only when the pressure in the cooking space has fallen so far that the piston 47 with its constriction 101 has reached the level of the keyhole type hole 99 of the sliding part 80 that this sliding part 80 in FIG. 13 can be displaced to the front to release the aperture 24.

Through the part 100 of the aperture, which is extended as a type of elongated hole, in the sliding part 80 it is however ensured that with a high pressure in the cooking space a very fast pressure relief is always possible. The movement of the operating element up to a maximum pulled-out position in which the lid 3 can be removed from the pot 2 is only possible after a specified minimum pressure has been undercut.

A pressure relief also with high pressure, but through a much smaller aperture, i.e. aperture 23, is achieved through the central position explained with reference to FIG. 6.

At high pressure a slow pressure reduction can be obtained therefore through the central position of the shaft 15 or of the actuating element 5. By pulling out the actuating element 5 or the shaft 15, the large aperture 24 can be released so that pressure can be quickly reduced. The actuating element can be pulled out to various extents so that variously large cross-sectional areas are provided for the pressure relief, thus giving different pressure relief rates which can be set by the user. With a valve on the aperture 24 completely open a pressure relief rate is given defined by the construction. With the apertures 23 and 24 various pressure relief rates are thus defined by the construction, whereas due to the adjustment of the degree of opening of the valve on the aperture 24, a variable pressure relief rate is given which can however assume values which are larger than the pressure relief rate given by the aperture 23.

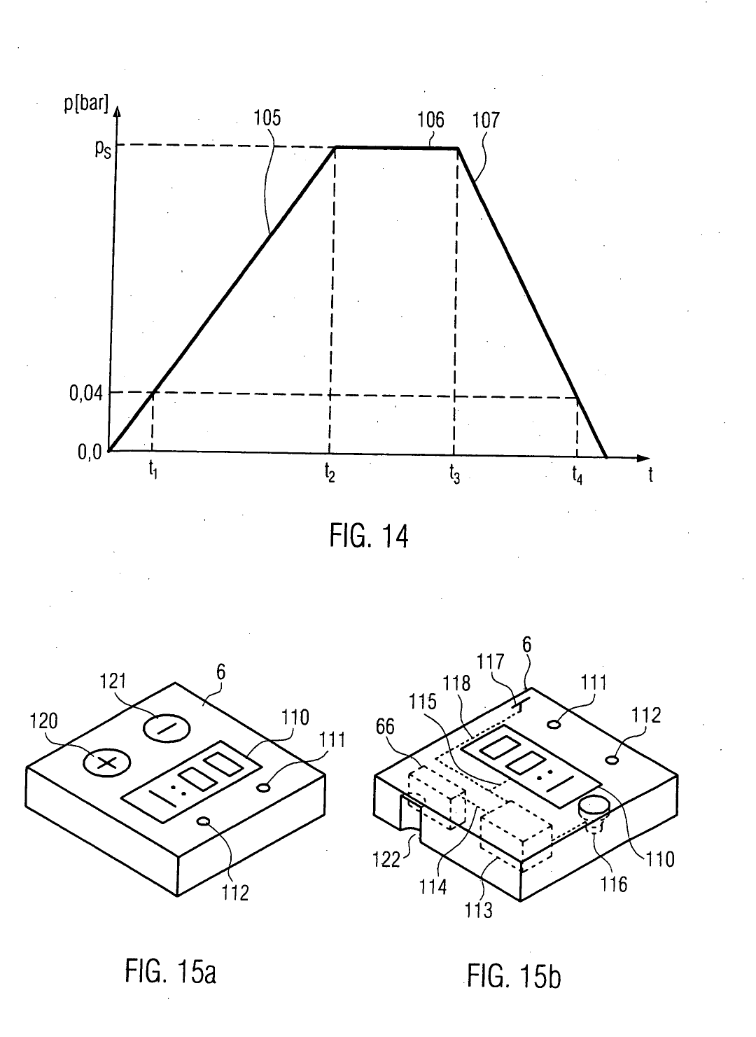

In FIG. 14 the pressure variation during a cooking process is schematically illustrated. Starting from an overpressure of 0 bar, a critical threshold value for the pressure is 0.04 bar. On reaching this pressure a pressure acquisition device acquires the exceeding of this pressure value. The pressure acquisition device can produce an electrical signal so that for example an LED in part 6 (refer also to FIG. 15) lights up continuously red or flashes red. This state remains from the time t1 to the time t4 at which this pressure value of 0.04 bar is again undercut.

After the time t1 the pressure rises again along the curve 105. This need not occur linearly as it appears in FIG. 14, but can occur in any manner. A time measurement starts on reaching a set specified pressure pₛ at the time t2. The pressure then does not further increase (see curve 106), because either steam escapes as it is let off or the energy supply is reduced. After the expiry of the time measurement a termination signal is produced. The energy supply to the pressure cooker is interrupted either manually or automatically so that the pressure p reduces (see curve 107). This can occur either in that the aperture 23 for slow pressure relief and in addition the aperture 24 for fast pressure relief are released and/or in that the temperature of the pressure cooker reduces. After undercutting the reference pressure of 0.04 bar an appropriate signal is produced so that for example a green LED indicator starts to light. This signals that the pressure cooker is essentially free of pressure or the residual pressure is so low that the pressure cooker can be opened without problem by removing the lid 3.

This green signal can be a continuous indication or also flashing. This signal occurs for a predetermined time, such as for example 5 minutes and thereafter the indicator goes out.

In FIG. 15 the electronic part 6 is schematically illustrated. FIG. 15a shows the upper side from the front. Operating elements 120, 121 are provided which are used for setting a time span. The set time span can for example be increased by one minute or one second using the plus button 120. The time span can be correspondingly reduced using the button 121.

Furthermore, a display 110 is provided in which the time span or a residual time of this time span is indicated. The display can be background-lit to improve the ease of reading.

The reference numerals 111, 112 identify the visual indicators, such as for example LEDs which can have various colours. Both visual indicators 111, 112 can also be integrated into one element which can light up in various colours in order to indicate the pressurised state or unpressurised state.

The LEDs can also protrude upwards from the electronic part 6 so that the visual signal can be easily seen from a direction to the side adjacent to the pot so that an operating person does not need to access the possibly hot and therefore hazardous region above the pot to read the signal. In this respect small domes can be provided for the LEDs or by the LEDs.

In FIG. 15b the electronic part 6 is shown rotated and the operating elements 120, 121 are omitted for the sake of clarity. At the back of the electronic part 6 which is visible in FIG. 15b there is an indentation 122. Adjacent to this indentation 122 the electronic detector 66 (refer to FIG. 8) is provided. The indentation 122 simplifies an arrangement of the pin 65 such that the detector 66 at least partly encloses the pin. The more the detector 66 encloses the pin 65, the easier or more precise the detection becomes. The pin 65 can also be completely enclosed by the electronic part 6 (in plan view). In this case there is an indentation, into which the pin 65 can protrude, on the underside of the electronic part, so that its position can be easily determined.

The electronic part 6 can be removed from the pressure cooker 1. The detector 66 and the pin 65 (in FIG. 8) operate without contact.

Using the detector 66 the position of the pin 65 is acquired in the electronic part 6 and thus a pressure or a specified pressure detected. The result of this detection is passed to a signal transmitter 113. This is connected to an acoustic output unit 116 of the visual output unit 110 (and/or indicators 111, 112) via a connection 115 and/or to an antenna 117 via a lead 118. Also only an antenna or only a visual indicator or only an acoustic indicator or any combination of these can be provided.

With the antenna 117 radio signals about the pressure or about time information or the information that a time span has expired or any other relevant information can be transmitted.

With the buttons 120, 121 or a further button a time measurement can also be initiated manually, for example by pressing the two buttons 120, 121 simultaneously.

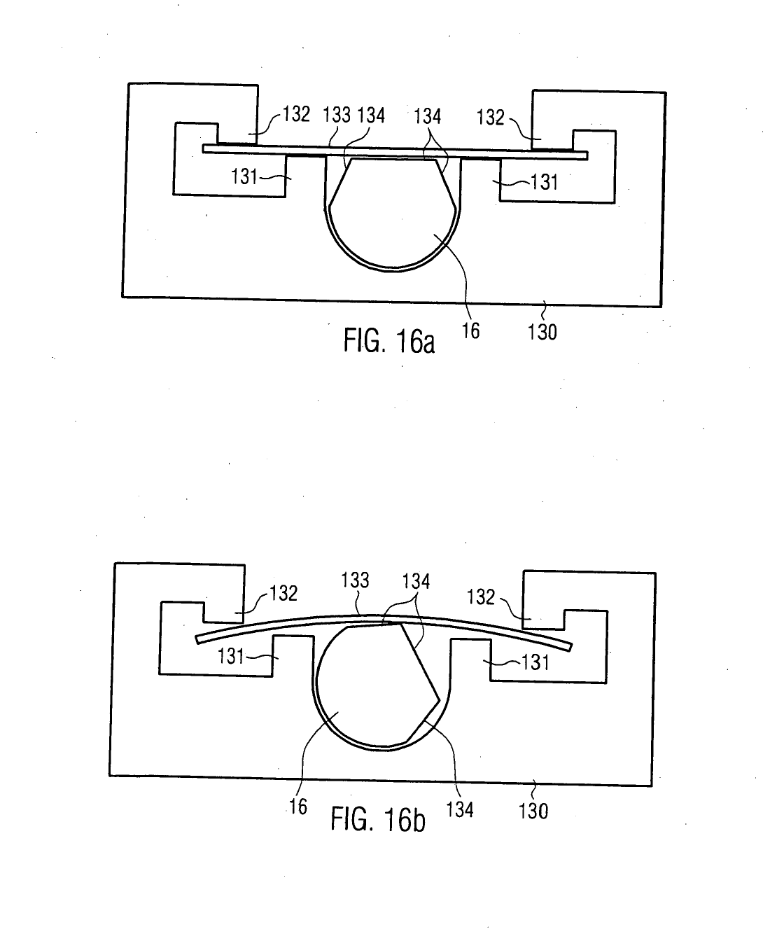

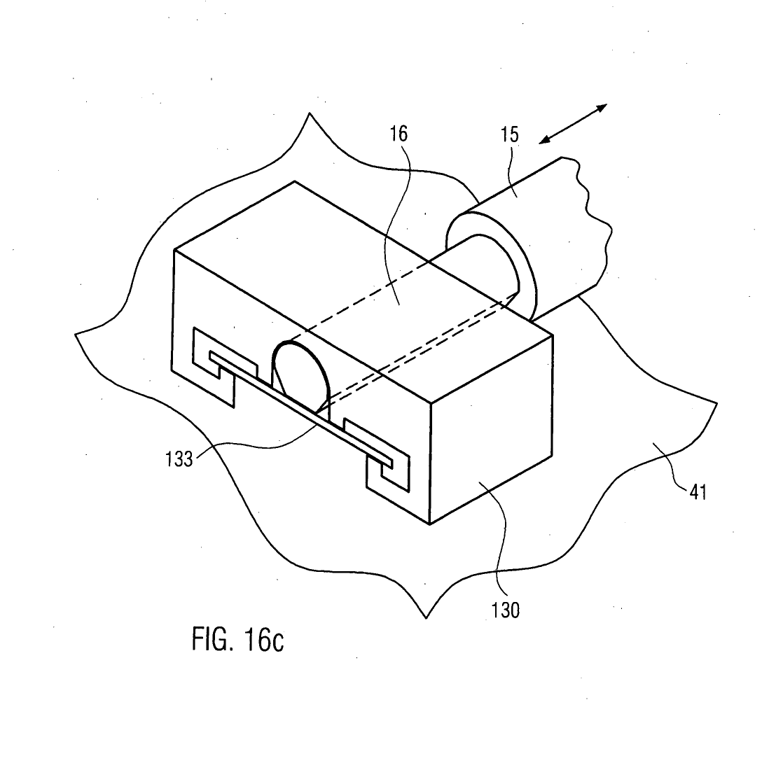

The support for the constriction 16 of the shaft 15 is illustrated in FIG. 16a. A leaf spring 133 is arranged in a pivot bracket 130. The constriction 16 has a number of flattened regions 134. Instead three flattened regions 134 on the circumference, also only one, two or more than three flattened regions can be provided. The flattened regions 134 interact with the leaf spring 133 such that latching positions on the shaft 15 are specified or reinforced. The leaf spring 133 is held in a pivot bracket 130. It is held on both sides of the shaft 15 between in each case two protrusions 131, 132. Using this construction even relatively thin leaf springs can be held precisely, even when the pivot bracket 130 exhibits some production inaccuracies in its dimensions.

In FIG. 16b it is shown how by rotation of the shaft 15 and thus of the constriction 16, the central flattened region 134 is moved away from the leaf spring 133 so that the leaf spring 133 is deflected. To achieve this a certain force is necessary which is felt on turning the shaft.

The arrangement of the pivot bracket 130 in the handle part 8 is illustrated in FIG. 16c. From above it is held by the (not illustrated) inner side of the upper side of the handle part 8, wherein appropriate brackets are provided for this in this inner side. The pivot bracket 130 is held in this position by the plate 41 so that it cannot drop out. Further fixing, such as with adhesive or special latching means, in the handle part 8 is possible, but can be omitted here, because the pivot bracket 130 is held by the plate 41. The shaft 15 can be moved in the direction of the double arrow.

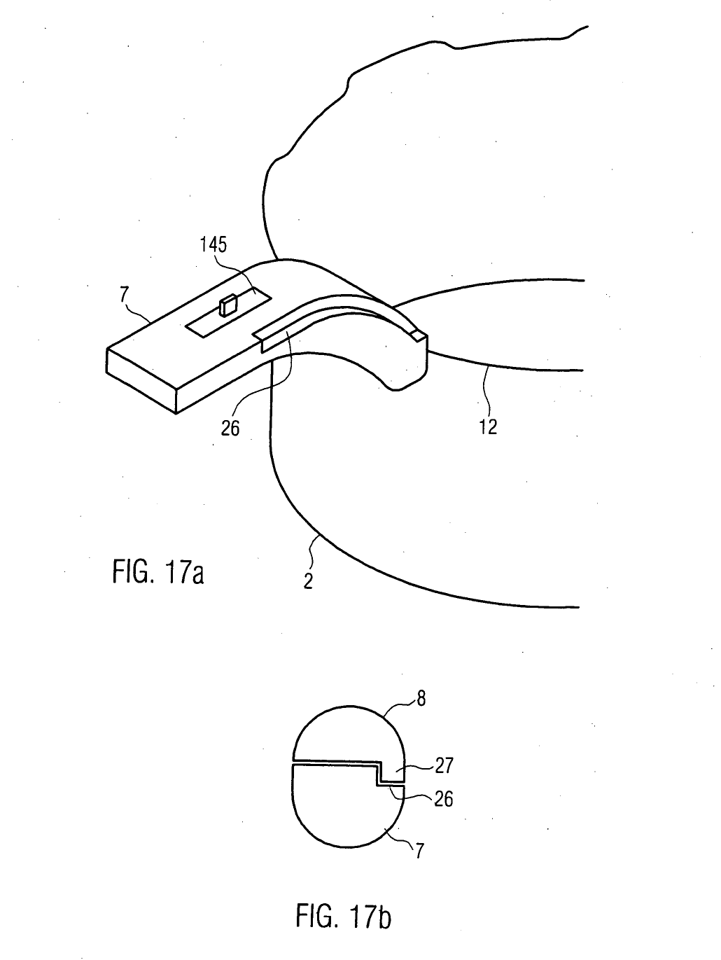

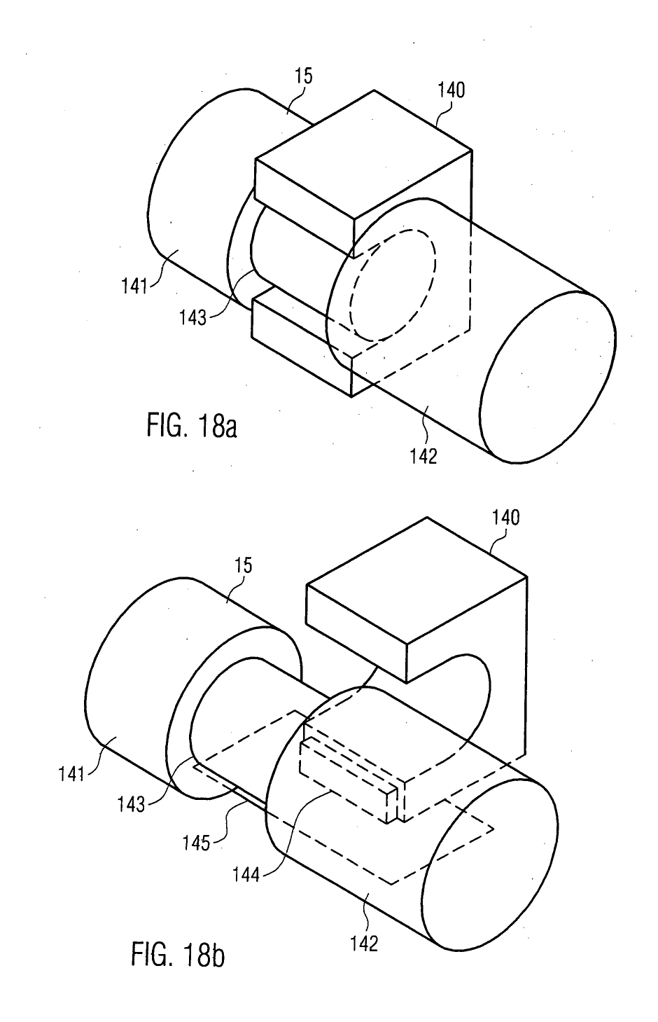

The handle part 7 from FIG. 2 is again illustrated enlarged in FIG. 17a. Here the recess 26 in the side facing the handle part 8 is shown enlarged at its edge. In FIG. 17b the handle parts 7 and 8 in the region of the recess 26 are shown as a sectional illustration. The protrusion 27 here fits exactly in the indentation 26. Through the indentation 26 and the protrusion 27 the handle part 8 can be rotated to the right with respect to the handle part 7 in FIG. 2 or 17. With a rotation to the left the protrusion 27 comes up against the inner face of the indentation 26 so that further rotation is prevented. This provides accurate positioning and simple placement of the lid 3 on the pot 2. The means, which facilitates this, are in relation to the lid and pot fixed parts.

In FIG. 17 a limit-stop element 145 is illustrated which is explained in more detail in conjunction with FIG. 18. The limit-stop element 145 is connected to the lower handle part 7. It can be fixed or also displaceable in the direction along the shaft 15 in the handle part 8.

In FIGS. 18a and 18b a locking mechanism for the shaft 15 is illustrated which is integrated into the handle 4. This locking mechanism prevents displacement of the shaft 15 for the case that the lid 3 is removed from the pot 2. The locking mechanism comprises a locking element 140 which is formed in a U-shape. It can engage a constriction 143 on the shaft 15 and thus prevent a displacement of the shaft 15 relative to the locking element 140. The locking element 140 is built into the upper handle part 8. It can be displaced in a direction in FIG. 18a from the bottom left to the top right in order to release the shaft 15. This is illustrated in FIG. 18b. The locking element 140 has here been displaced from the limit-stop element 144 in comparison to the shaft 15 to the top right. The limit-stop element 144 is provided in the handle part 7 on its upper side. The limit-stop element 144 can for example be provided on a type of shuttle 145 which carries the limit-stop element. With the situation as illustrated in FIG. 18b, the shuttle can be displaced together with the shaft 15 or also be fixed so that the shaft 15 is pushed past the limit-stop element 144.

The locking element 140 is pretensioned in a direction to the position in which the shaft is locked, e.g. by a spring element. From this position it is only on closing the pot 2 with the lid 3 that it moves out, because it abuts the limit-stop element 144 on rotation of the lid 3 so that with the lid 3 in place and brought into the cooking position (refer to FIG. 1), the shaft 15 is released for linear displacement.

1. Pressure cooker, comprising a handle (4) and an operating element, the operating element including a rotating shaft (15).

2. Pressure cooker according to claim 1, wherein the handle (4) protrudes sideways from the pressure cooker (1).

3. Pressure cooker according to claim 2, wherein the rotating shaft (15) is accommodated in the handle (4.

4. Pressure cooker according to claim 1, wherein the rotating shaft (15) extends from a region to a side of a cooking space (11) up to a region above the cooking space (11).

5. Pressure cooker according to claim 1, wherein the rotating shaft (15) is provided with an actuating element (5).

6. Pressure cooker according to claim 5, wherein the actuating element (5) is arranged completely to the side of a cooking space (11).

7. Pressure cooker according to claim 1, wherein the rotating shaft (15) can be brought into one of at least two, three, four or more predefined rotary positions.

8. Pressure cooker according to claim 1, wherein on the rotating shaft (15) at least one cam (42, 53, 74) is provided with which mechanical elements of the pressure cooker (1) can be adjusted.

9. Pressure cooker according to claim 8, wherein for each of the at least one cams, at least one rocker element (54, 59, 70) is provided, each of which at least one rocker element interacts with the respective at least one cams (53, 74).

10. Pressure cooker according to claim 1, wherein the maximum specified pressure of the pressure cooker (1) can be set by rotation of the rotating shaft (15).

11. Pressure cooker according to claim 1, wherein the initiation pressure for a time acquisition can be set by rotation of the rotating shaft (15).

12. Pressure cooker according to claim 1, and an aperture (23) for pressure relief which can be opened or closed by rotation of the rotating shaft (15).

13. Pressure cooker according to claim 1, wherein the rotating shaft (15) for operating the pressure cooker can be linearly displaced.

14. Pressure cooker according to claim 1, and an aperture (24) in the pressure cooker for pressure relief which can be opened or closed through linear displacement of the rotating shaft (15).

15. Pressure cooker according to claim 1, and a pressure valve (34) which can be pretensioned by an elastic element, which pretension can be varied by one of the rotation or displacement of the rotating shaft (15).

16. Pressure cooker according to claim 1, and a pressure measurement device (35) which can be pretensioned by an elastic element, which pretension can be varied by the rotation of the rotating shaft (15).

17. Pressure cooker according to claim 16, wherein the pressure measurement device (35) comprises an electronic evaluation device (66).

18. Pressure cooker according to claim 17, wherein the pressure measurement device (35) comprises a measuring element (65), displaceable by the pressure, wherein an electronic evaluation device (66) acquires the position of the displaceable measuring element (65) for the pressure determination.

19. Pressure cooker according to claim 18, wherein the relationship between the pressure in the pressure cooker (1) and the position of the displaceable measuring element (65) is changed by the variation of the pretension of the pressure measurement device (35).

20. Pressure cooker according to claim 19, wherein a hole (51) is provided in the housing so that the displaceable measuring element (65) can be brought into an idle position from outside, through which a pin can be pushed to bring the displaceable measuring element (65) into the idle position.

21. Pressure cooker according to claim 1, wherein the rotating shaft (15) is one of straight, flexible, and provided with one or more flexible points.

22. Pressure cooker (1), comprising an operating element (15) with which pressure can be vented from the pressure cooker through an aperture, and means for facilitating pressure to be relieved with one of at least two specified different pressure relief rates or with at least one specified pressure relief rate and with a pressure relief rate, adjustable up to greater values than the specified value.

23. Pressure cooker according to claim 22, wherein two different apertures are provided for pressure relief.

24. Pressure cooker according to claim 23, wherein the two apertures (23, 24) have different discharge resistances.

25. Pressure cooker according to claim 24, wherein at least one of the apertures (23, 24) has a discharge resistance which is influenced by the pressure in the pressure cooker (1).

26. Pressure cooker according to claim 22, wherein the aperture (23) has a minimum discharge cross-sectional area of no more than one of 0.1, 0.2, 0.5, 1.0, 1.5, 2.0, 2.5 or 3.0 mm².

27. Pressure cooker according to claim 22, wherein the aperture (23) when fully open has a discharge resistance such that the pressure in the pressure cooker can reduce from 1 bar overpressure to 0.04 bar overpressure in a time of at least one of 10 s, 20 s, 30 s, 40 s, 50 s, 1 min, 1 min 15 s, 1 min 30 s, or 2 min.

28. Pressure cooker according to claim 23, wherein one of the two apertures (24) when fully open has a discharge resistance such that the pressure in the pressure cooker can reduce from 1 bar overpressure to 0.04 bar overpressure in a time of no more than one of 15 s, 10 s, 8 s, or 5 s.

29. Pressure cooker according to claim 23, wherein both apertures (23, 24) can be operated with the same operating element (15).

30. Pressure cooker according to claim 22, wherein the aperture (23) can be closed by the operating element (15) in that the operating element (15) presses with a mechanically strong part (42) onto an elastic sealing element (40).

31. Pressure cooker according to claim 22, wherein the operating element (15) varies the pretension of an elastic element.

32. Pressure cooker according to claim 23, wherein one of the first, second, or both apertures (23, 24) is provided in the removable lid (3) of the pressure cooker (1).

33. Pressure cooker (1), comprising an operating element (15) for opening and closing an aperture in pressure cooker (1), and a second operable aperture (23) of the pressure cooker (1).

34. Pressure cooker, comprising a pressure acquisition device having a mechanical part (45-67) with at least one part (56, 65) which is movable by the pressure, and an electronic part (66) which can acquire the position of the movable part (56, 65) to determine the pressure.

35. Pressure cooker according to claim 34, wherein the mechanical part of the pressure acquisition device (35) is adjusted such that the relationship between the pressure and the position of the movable part (56, 65) is changed.

36. Pressure cooker according to claim 35, wherein the position of the movable part (56, 65), which corresponds to a set specified pressure, is approximately the same for different selected specified pressures.

37. Pressure cooker according to claim 34, wherein the mechanical part (56, 65) and the electronic part (66) interact with one another without making contact.

38. Pressure cooker according to claim 34, wherein the electronic part (6, 66) can be removed from the mechanical part.

39. Pressure cooker according to claim 34, wherein the electronic part (66) of the pressure acquisition device comprises a signal transmitter (113) which can produce a signal depending on the acquired pressure.

40. Pressure cooker according to claim 39, wherein the signal transmitter (113) comprises one of a visual indicator (110, 111, 112), a display (110), and an acoustic signal generator (116).

41. Pressure cooker according to claim 39, wherein the signal transmitter comprises a radio signal generation device (117).

42. Pressure cooker according to claim 39, wherein the signal transmitter (113) is formed such that on one of exceeding or undercutting one or more predefined specified pressures a signal is produced.

43. Pressure cooker according to claim 39, wherein the signal transmitter (113) is formed such that on one of exceeding or undercutting one or more specified pressures a signal can be issued for a preset time.

44. Pressure cooker according to claim 39, wherein the signal transmitter (113) produces a signal one of continuously or quasi-continuously which represents the pressure one of absolutely or relatively to a set value.

45. Pressure cooker according to claim 39, wherein the signal transmitter (113) is formed such that after undercutting a specified pressure a signal is only output for a predefined time.

46. Pressure cooker according to claim 34, wherein the pressure acquisition device (35) is coupled to a time measurement device (113).

47. Pressure cooker according to claim 34, wherein a hole (51) is provided in the housing so that the mechanical part can be brought into an idle position from outside, through which a pin can be pushed to bring the displaceable measuring element (56, 65) into the idle position.

48. Pressure cooker (1) having a time measurement device (113).

49. Pressure cooker according to claim 48, wherein the time measurement device (113) is coupled to a pressure acquisition device (35, 56, 65, 66).

50. Pressure cooker according to claim 49, wherein the time measurement device (113) is coupled to the pressure acquisition device (35, 56, 65, 66) such that the exceeding of an adjustable specified pressure initiates a time measurement.

51. Pressure cooker according to claim 50, wherein the pressure acquisition device (35) can be adjusted such that the specified pressure at which the time measurement is initiated is selectable.

52. Pressure cooker according to claim 48, wherein the time measurement device (113) comprises an actuation device (120, 121) with which a time measurement can be initiated.

53. Pressure cooker according to claim 48, and wherein adjustment means (120, 121) are provided with which a time span can be set and wherein the time measurement device calculates the remaining time of the time span from an initiation of a time measurement.

54. Pressure cooker according to claim 48, wherein the time measurement device (113, 6) can be removed.

55. Pressure cooker according to claim 54, wherein the time measurement device (113, 6) is functional in the removed state in so far as it can continue a started time measurement.

56. Pressure cooker according to claim 48, wherein the time measurement device (113) is formed for the generation of a termination signal after expiry of a set time span.

57. Pressure cooker according to claim 56, and wherein a sound generator (116) is provided which can output a termination signal.

58. Pressure cooker according to claim 56, and a visual indicator is provided with which a termination signal can be output.

59. Pressure cooker according to claim 51, and means (113) for outputting the termination signal for a set time are provided.

60. Pressure cooker, comprising of a lid (3) to which a handle part (8) can be fitted, with a pot (2) to which a second handle part (7) is fitted, wherein the two handle parts (7, 8) can be brought to abutment with one another by movement of the two handle parts (7, 8) towards one another.

61. Pressure cooker, comprising a lid (3), a handle part (8) on the lid (3), wherein in the handle part (8) a linearly displaceable element (15) can be locked by a displaceably supported U-shaped locking element (140), such that linear displacement is restricted.

62. (canceled)

63. Pressure cooker according to claim 3, wherein the rotating shaft (15) is accommodated in the sideways protruding part of the handle (4).

64. Pressure cooker according to claim 5, wherein the actuating element is at the end of the handle.

65. Pressure cooker according to claim 7, wherein the rotary positions are latching positions, which provide settings for the pressure cooker (1).

66. Pressure cooker according to claim 15, wherein the elastic element is a spring (87).

67. Pressure cooker according to claim 16, wherein the elastic element is a spring (50).

68. Pressure cooker according to claim 17, wherein the electronic evaluation device (66) can acquire the pressure, attain one or more pressure levels, exceed one or more pressure levels, and undercut one or more pressure levels.

69. Pressure cooker according to claim 24, wherein the different discharge resistances are due to different minimum discharge cross-sectional areas.

70. Pressure cooker according to claim 25, wherein the discharge resistance occurs due to one of a pressure reduction valve or a valve which changes its cross-sectional area according to pressure.

71. Pressure cooker according to claim 31, wherein the elastic element is a spring (87) of a pressure valve (34).

72. Pressure cooker according to claim 38, wherein the electronic part (6, 66) can be removed without tools.

73. Pressure cooker according to claim 40, wherein the visual indicator comprises one or more LEDs (111, 112).

74. Pressure cooker according to claim 40, wherein the acoustic signal generator comprises one of a sounder or loudspeaker.

75. Pressure cooker according to claim 41, wherein the radio signal generation device comprises an antenna and the associated electronics.

76. Pressure cooker according to claim 45, wherein the specified pressure is approximately 0.04 bar.

77. Pressure cooker according to claim 51, wherein the adjustment is one of mechanical, electrical, or both.

78. Pressure cooker according to claim 53, and wherein the calculated remaining time can be displayed.

79. Pressure cooker according to claim 57, wherein the sound generator is one of loudspeaker or a sounder.

80. Pressure cooker according to claim 58, wherein the visual indicator is one or more LEDs or one or more displays.

81. Pressure cooker according to claim 60, and fixed means to facilitate the abutment.

82. Pressure cooker according to claim 60, wherein the fixed means comprises an indentation and a protrusion.

83. Pressure cooker according to claim 61, wherein the linearly displaceable element (15) is a linearly displaceable shaft.
